(19) United States
(12) Patent Application Publication
(10) Pub. No.: US 2015/0266551 A1
(43) Pub. Date: Sep. 24, 2015

(54) EXTERNAL BOAT MOUNTED RECEPTACLE SUPPORT BRACKET

(71) Applicants: Elkin Sanchez, Pembroke Pines, FL (US); Eloy Rodriguez, Pembroke Pines, FL (US)

(72) Inventors: Elkin Sanchez, Pembroke Pines, FL (US); Eloy Rodriguez, Pembroke Pines, FL (US)

(21) Appl. No.: 14/664,830

(22) Filed: Mar. 21, 2015

Related U.S. Application Data
(60) Provisional application No. 61/969,104, filed on Mar. 22, 2014.

(51) Int. Cl. B63B 25/00; F16M 13/02

(52) U.S. Cl. CPC B63B 25/002; F16M 13/022

(57) ABSTRACT

A receptacle support bracket for supporting an item on the exterior of a boat comprises a hoop, an arm and a post. The receptacle support bracket may include one or more pivoting or rotating joints to allow the hoop portion to be rotated or moved relative to the post. The post fits into and engages the rod holders found on conventional boats. The hoop may be used to hold a variety of containers includes waste baskets, trash bags, nets and the like.

### CROSS-REFERENCE TO RELATED APPLICATIONS

This application claims priority to U.S. Provisional Application Ser. No. 61/969,104 filed on Mar. 22, 2014, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

1. Field of Endeavor

The present invention relates to systems and methods for providing a receptacle support bracket. More particularly, the invention relates to a receptacle support bracket having a post for engaging a rod holder or other cylindrical retention device and an arm extending from the post to a hoop device.

2. Background Information

Boats have a limited amount of space and efficiency in use of it is highly desirable. Boats often use every possible space for one or more purposes. Storage and bait wells may be placed underneath benches and seats. Using the deck for storing anything other than essentials is not desired. As a result, many devices have been designed to affix to the gunwales and/or transoms of a boat. Grills are often attached to gunwales or railings.

Conventional ways of attaching these accessories to a boat include permanently drilling through the structural portion and permanently attaching the accessory thereto. Drilling of this type, however, detracts from the otherwise pleasant aesthetic appearance of the boat and/or may affect the structural integrity of the structural portion of the boat as a whole. Further, once an accessory is permanently attached, it cannot be easily removed or hidden from view, thereby affecting the overall aesthetic appearance of the boat itself. In addition to the above, permanently attaching these accessories, for example, to the gunnel of the boat, makes that portion of the gunnel unavailable for other uses or other attachments. In addition, in such case, the pre-defined length and shape of the gunwales limits the number of attachments that can be attached to the boat.

Fishing rod holders are typically located on the outer perimeter of a boat. Boats often have many more fishing rod holders than are needed by the occupants of the boat.

Accordingly, it would be desirable to have an apparatus and related method to address this and other problems associated with the attachment of accessories to a boat.

### BRIEF SUMMARY OF THE INVENTION

Accordingly, the primary object of the present invention is to provide a mountable receptacle support bracket for use with a boat and a rod holder on a boat.

In greater detail, a receptacle support bracket comprises a hoop, an arm and a post. The hoop may be used to support or hold a waste basket or other object. The arm may extend outward from the boat and rod holder and support the hoop. The post may fit into and engage a rod holder while supporting the arm and hoop.

In one embodiment, a boat mounted receptacle support bracket comprising an elongate post having a top and a bottom, the bottom inserted into a fishing rod holder on a boat and the top protruding upward out of the fishing rod holder. The bracket also includes a receptacle support bracket and a cantilever arm having a proximal end attached to the top of the post and a distal end attached to the receptacle support bracket.

In another embodiment, the boat mounted receptacle support bracket includes a post, the receptacle support bracket and the cantilever arm formed as a single unitary body. The support bracket comprises a rigid hoop and may be a partial rigid hoop.

In another embodiment, a boat mounted receptacle support bracket has a partial hoop including a first prong and a second prong. A retractable ribbon extends from a distal end of the first prong and is removably attachable to the distal end of the second prong. The support bracket comprises a flexible hoop. The cantilever arm may comprise a pivot joint providing rotation about a longitudinal axis.

In another embodiment, the boat mounted receptacle support bracket includes a cantilever arm further comprises a pivot joint providing rotation about a transverse axis. The top of the post further comprises a pivot joint providing rotation about a transverse axis allowing the post to be rotated to a position flush with the cantilever arm. An anchor at the bottom of the post secures the post within the fishing rod holder. The anchor may be a toggle bolt, including a butterfly toggle bolt. The receptacle support bracket may include a net.

It is therefore an object of the present invention to provide a means for providing a hoop configured to support for use on a boat that does not diminish the space within the boat available for the operators and users of the boat.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a top plan view of a receptacle support bracket in accordance with the principles of the invention;

FIG. 2 is a side view of a receptacle support bracket in accordance with the principles of the invention;

FIG. 3 is a top plan view of an alternative embodiment of a receptacle support bracket in accordance with the principles of the invention;

FIG. 4 is a side view of an alternative embodiment of a receptacle support bracket in accordance with the principles of the invention;

FIG. 5 is a top plan view of an alternative embodiment of a receptacle support bracket in accordance with the principles of the invention;

FIG. 6 is a side view of an alternative embodiment of a receptacle support bracket in accordance with the principles of the invention;

FIG. 7 is a top plan view of an alternative embodiment of a receptacle support bracket in accordance with the principles of the invention;

FIG. 8 is a side view of an alternative embodiment of a receptacle support bracket in accordance with the principles of the invention;

FIG. 9 is a top plan view of an alternative embodiment of a receptacle support bracket in accordance with the principles of the invention;

FIG. 10 is a top plan view of an alternative embodiment of a receptacle support bracket in accordance with the principles of the invention;

FIG. 11 is a side view of an alternative embodiment of a post for a receptacle support bracket in accordance with the principles of the invention;

FIG. 12 is a side view of an alternative embodiment of a post for a receptacle support bracket in accordance with the principles of the invention;

FIG. 13 is a perspective view of an alternative embodiment of a receptacle support bracket in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is a support bracket mountable on a boat such that it extends externally from the boat and supports an item such as a net or waste receptacle exterior to a boat. In this manner, objects may be incorporated into the use of a boat without reducing the space available for users and operators of the boat. The bracket may be adjusted to optimize the position and location of objects supported or held by it. The support bracket may be used to hold a wastebasket, trash bag, net, or other receptacle and may optionally include a lid. The frame of the bracket may be circular, rectangular or have another shape and is generally intended to hold a receptacle, such as a waste basket, net or cannister. The principles of the invention allow a waste basket or other cannister to be positioned external to a boat in order to maximize the amount of room available for occupants and other objects. The receptacle support bracket may preferably be comprised of a durable, sturdy material to provide adequate support for whatever object it may hold.

The embodiments disclosed herein are described primarily as a device for use with a boat or watercraft. However, the principles of the invention may be applied to other vessels, such as cars, trucks, buses, vans, larger watercraft including yachts and oceangoing vessels, and any other object to which it may be desirable to attach a device in accordance with the principles of the invention.

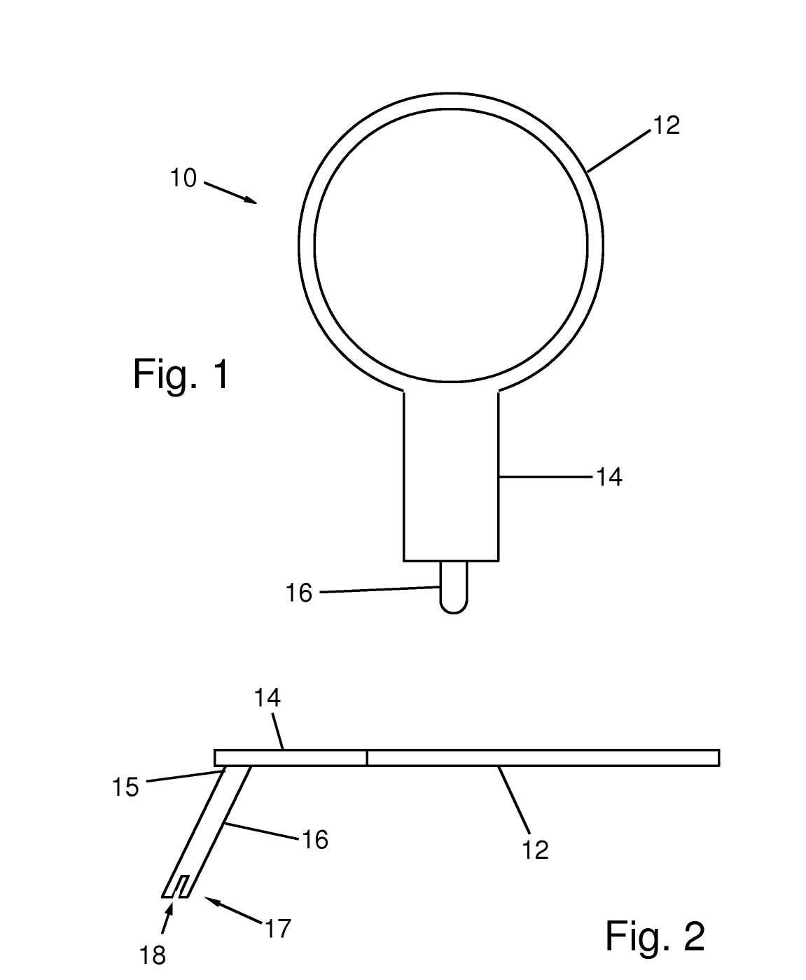

FIGS. 1 and 2 show a receptacle support bracket 10 having a frame 12, a cantilever arm 14 and a post 16. In this embodiment, the frame 12 and cantilever arm 14 are manufactured as a single, unitary body. The frame 12 may be designed to retain, hold, or otherwise removably attach to an object. In this embodiment, the frame 12 may be hoop-shaped having a substantially circular configuration and may be formed from any suitably rigid and sturdy material such as for example steel, metal, metal alloy, aluminum, wood, plastic, carbon fiber, and the like. Circular frame 12 may be strong enough to support a wastebasket or other object and may preferably be capable of supporting several pounds of weight. Optionally, the hoop shaped frame 12 may be sufficiently malleable such that its shape may be adjusted by bending. The circular frame may optionally include clips for securing a bag such as a trash bag.

The cantilever arm 14 in this embodiment may be substantially planar and have a substantially rectangular configuration. The frame 12 and cantilever arm 14 may lie in the same plane as may be seen in FIG. 2. This may simplify the manufacturing process. Optionally, the cantilever arm 24 may be narrower and may be cylindrical, or in the shape of a rod and similar to post 16. The frame 12 may also optionally have a cross section that is rectangular, circular or other shape.

The cantilever arm 14 may connect to the post 16 by means of a joint 15. The post 16 may be connected to the cantilever arm 14 by any suitable mechanism, including, screws, nuts and bolts, welding, clamps, and the like. The cantilever arm 14 post 16 may be permanently affixed to one another, or may optionally be removably attached. Optionally, joint 15 may allow for rotation or pivoting upon one or more axes.

The post 16 may extend downward from cantilever arm 14 and may be scaled to fit within a fishing rod holder as commonly found on boats. The bottom 17 of the post 16 may include one or more slots 18 that may allow the post to engage structures at the base of the rod holder to prevent rotation. The post 16 may extend at an angle such that, when it is fitted within a rod holder, the arm 14 and hoop 12 may be substantially horizontal and parallel to the deck of the boat.

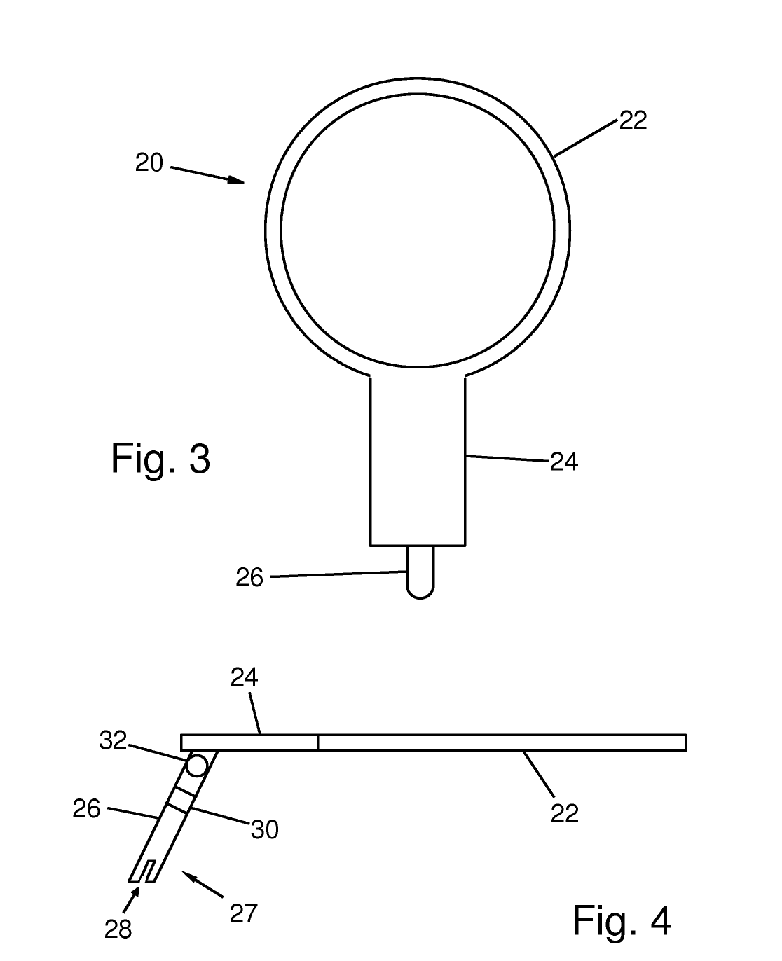

FIGS. 3 and 4 show an alternative embodiment of a receptacle support bracket 20 including a frame 22, a cantilever arm 24 and a post 26. The bottom 27 of the post 26 may include one or more slots 28 may allow the post to engage structures inside the rod holder to prevent rotation. In this embodiment, the post 26 includes two joints 30 and 32. Joint 30 may allow the post 26 to rotate or twist. The joint 32 may permit rotation about an axis transverse to the length of post 26 and parallel to the plane formed by cantilever arm 24. This may allow the cantilever arm 24 and frame 22 to be raised and lowered.

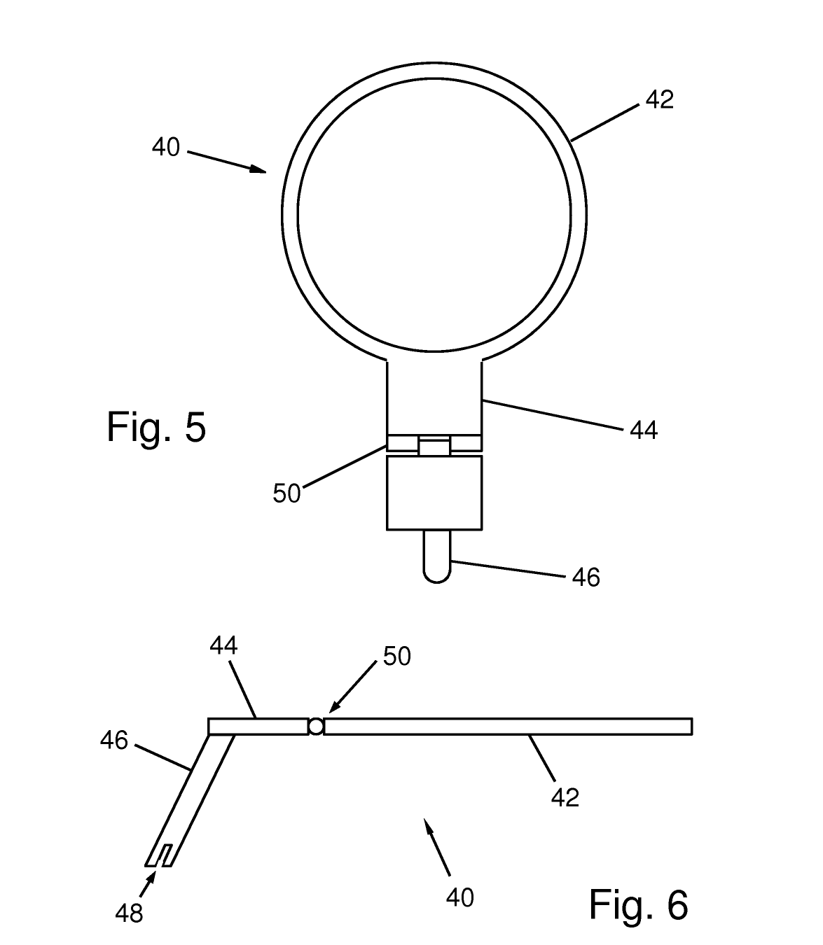

FIGS. 5 and 6 show an alternative embodiment of a receptacle support bracket 40 in accordance with the principles of the invention. The bracket 40 may have a frame 42 having a hoop or circular configuration, a cantilever arm 44 and a post 46. The cantilever arm 44 may include a pivot joint 50 having an axis parallel with the plane of the cantilever arm 44 and circular frame 42. The joint 50 may allow the hoop to be raised and lowered in a manner similar to joint 32 of FIG. 4. The post 46 may include a slot 48 that may engage structures at the base of a rod holder and thereby prevent rotation of the post 46.

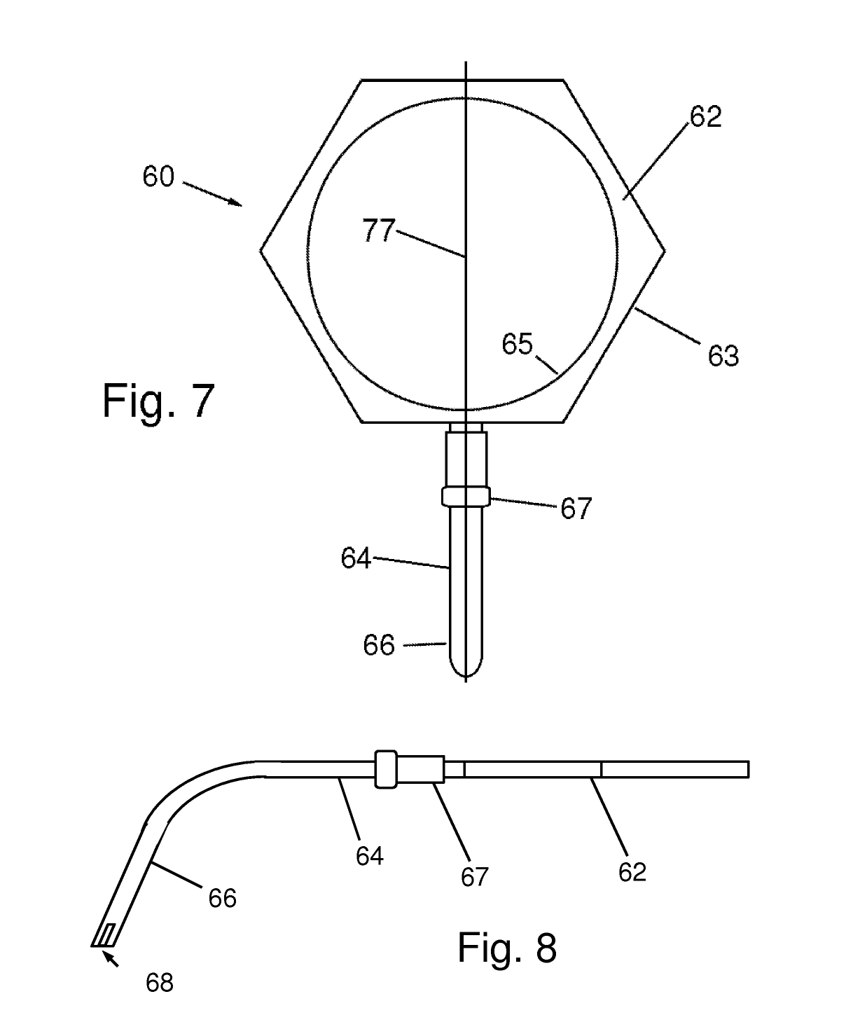

FIGS. 7 and 8 show another alternative embodiment of the invention. The embodiment shown in FIGS. 7 and 8 may be generally illustrative of alternative possibilities for the physical structure of a receptacle support bracket in accordance with the principles of the invention. Receptacle support bracket 60 may include a frame 62, a cantilever arm 64 and a post 66. In this embodiment, the frame 62 may have a circular inner opening 65 and a hexagonal outer perimeter 63. It is generally not necessary for the frame to have a circular or hoop configuration. The frame 60 may optionally be rectangular, elliptical, or any other desired geometry. The cantilever arm 64 in this embodiment is cylindrical and connected to frame 62 by a locking pivot joint 67 that may allow the frame 62 to be rotated about the longitudinal axis 77 of the cantilever arm 64.

As may also be seen in this embodiment, the cantilever arm 64 and the post 66 may be formed as a single unitary body. The cantilever arm 64 and the post 66 may be comprised of a single pipe or rod that has been bent to a desired angle. It may be seen that the frame, cantilever arm and post of a receptacle support bracket in accordance with the principles of the invention may be embodied in a plurality of varying geometric forms, depending upon the uses to which they are applied. It may also be desirable for the frame of the support bracket to include clamps, brackets, notches, tabs, clips or other mechanisms for securing various objects within the frame. The frame may be used to hold a wastebasket, a trash bag, a fishing net, or any other suitable device.

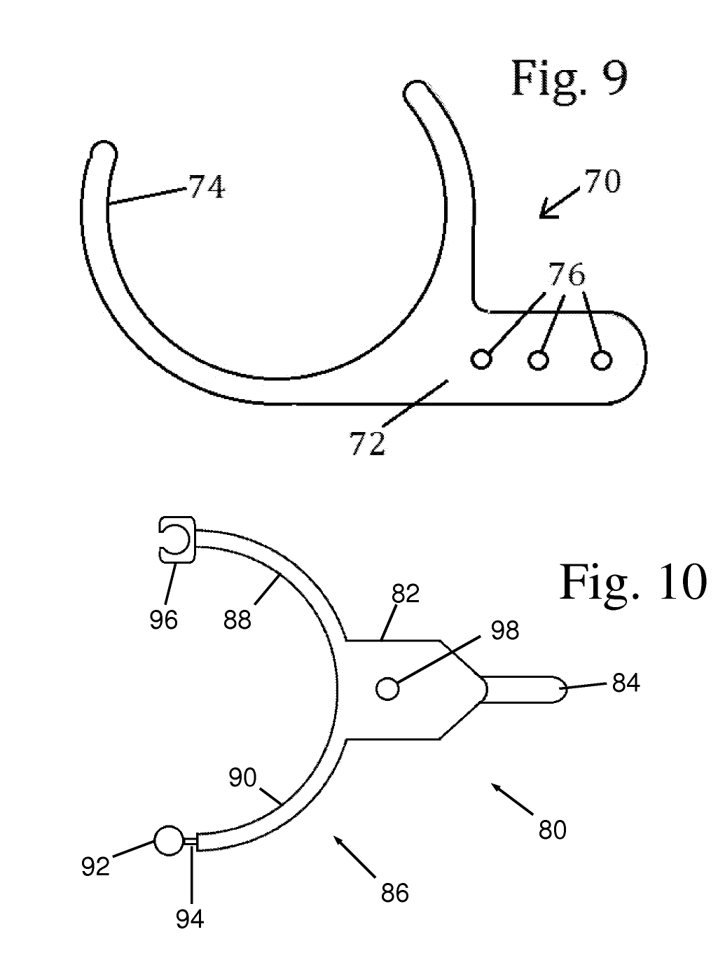

FIG. 9 shows an alternative embodiment of a receptacle support bracket 70 having a cantilever arm 72 and a frame hoop 74. The cantilever arm 72 may include holes 76 for accommodating bolts, screws, dowels or other mechanisms for securing it to a bracket, not shown. By providing a plurality of holes in the cantilever arm, it may be attached to a bracket having posts in different configurations. Optionally, the holes 76 may be replaced with threaded posts for attachment to a post having one or more holes. Optionally, cantilever arm 72 may include one or more mechanisms for attachment to a post, bracket or other device.

The frame 74 of receptacle support bracket 70 has a crescent or partial circular configuration. This design may be desirable depending on the device being held by the support bracket 70. The frame 74 may be comprised of a semi-rigid or partially flexible material that may allow it to flex such that a device may be secured by increased static friction provided by use of a container or other device in the frame 74.

FIG. 10 shows another alternative embodiment of a receptacle support bracket 80. The support bracket 80 may include a post 84, a cantilever arm 82 and a frame 86. In this embodiment, the frame 86 may have a crescent shape formed by two prongs 88 and 90. The first prong 88 may include a clasp 96 at its distal end. The second prong 90 may have an extendable and retractable ribbon 94 extending from its distal end. The ribbon 94 may include a knob 92 that may removably engage the clasp 96. A button 98 on the cantilever arm 82 may actuate an internal spring that biases and retracts the ribbon 94 when depressed. This embodiment may be desirable in order to accommodate receptacles are other objects of many different sizes. In this embodiment, the prongs 88 and 90 of the frame 86 form substantially a half circle. It may be desirable for the prongs 88 and 92 be longer or shorter. Optionally the frame 86 may be completely replaced with the ribbon and clasp mechanism shown here or by a similar device.

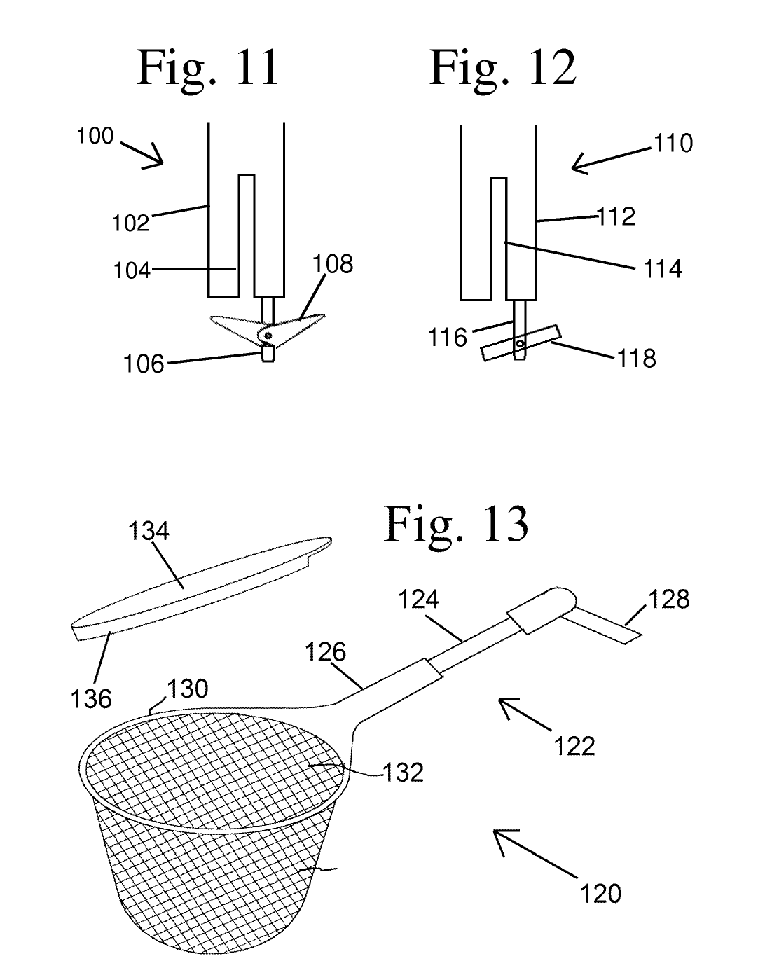

FIG. 11 shows an alternative embodiment of a post 100. The post 100 may have a bottom 102 having a slot 104 for accommodating a cross shaped structure frequently found at the bottom of a fishing rod holder. The bottom 102 of the post 100 may also include a rod 106 extending downward and having an anchor mechanism 108. In this embodiment, anchor mechanism 108 is a type of toggle bolt commonly referred to as a butterfly bolt or a butterfly anchor. When the post 100 and is slid downward into a fishing rod holder, the rod 106 may protrude out from the bottom of the fishing rod holder and the butterfly toggle bolt 108 may pop open, thereby securing the post and the receptacle support bracket within the fishing rod holder. This may prevent the support bracket from falling out of the fishing rod holder in rough seas. When the support bracket is removed, an operator may squeeze closed the butterfly toggle bolt 108 so that the post may be removed from the fishing rod holder.

FIG. 12 shows another alternative embodiment of a post 110. The post 110 may have a bottom 112 having a slot 114 for accommodating a cross shaped structure as described above. The bottom 112 of the post 110 may also include a rod 116 extending downward and having an anchor mechanism 118. Anchor mechanism 118 is another type of toggle bolt. Other toggle bolts or similar mechanisms may be used to perform the same function. Both rod 106 of FIG. 11 and rod 116 of FIG. 12 may optionally be retractable within the posts 100 and 110, respectively.

FIG. 13 shows another alternative embodiment of a receptacle support bracket 120. In this embodiment, a frame 130 extends from a cantilever arm 122 which may also be affixed to a post 128. In this embodiment, the cantilever arm 122 includes an outer pipe 126 that may telescope along the length of the arm body 124. The frame 130 includes a net 132. The net 132 may be designed for use while fishing and may optionally of be adapted to contain other objects, including waste. This embodiments also includes a lid 134 having a small annular lip 136. It may be desirable to cover a frame 130 and/or a receptacle or other object held by the frame. Optionally, the lid 130 may be adapted to serve other functions. For example, the lid 134 may include cupholders, a small cooler or ice chest, watertight compartments, an MP3 player or other electrical devices or the like.

Optionally, the receptacle support bracket may incorporate one or more decorative features. It may be painted a preferred color and may include engravings or embossing of symbols or designs, for example, sports team logos and trademarks. Those skilled in the art will appreciate that the invention disclosed herein, may be applied in multifarious ways to provide a receptacle support bracket for a plurality of uses and environment.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A boat mounted receptacle support bracket comprising:
an elongate post having a top and a bottom, the bottom inserted into a fishing rod holder on a boat and the top protruding upward out of the fishing rod holder;
a frame for supporting an object;
a cantilever arm having a proximal end attached to the top of the post and a distal end attached to the receptacle support bracket.

2. The boat mounted receptacle support bracket of claim 1 wherein the post, the frame and the cantilever arm are formed as a single unitary body.

3. The boat mounted receptacle support bracket of claim 1 wherein the frame comprises a circular hoop.

4. The boat mounted receptacle support bracket of claim 1 wherein the frame comprises a partially circular hoop.

5. The boat mounted receptacle support bracket of claim 1 wherein the partial hoop includes a first prong and a second prong, wherein a retractable ribbon extends from a distal end of the first prong and is removably attachable to the distal end of the second prong.

6. The boat mounted receptacle support bracket of claim 1 wherein the frame comprises a flexible hoop.

7. The boat mounted receptacle support bracket of claim 1 wherein the cantilever arm further comprises a pivot joint providing rotation about a longitudinal axis of the cantilever arm.

8. The boat mounted receptacle support bracket of claim 1 wherein the cantilever arm further comprises a pivot joint providing rotation perpendicular to a longitudinal axis of the cantilever arm.

9. The boat mounted receptacle support bracket of claim 1 wherein the top of the post further comprises a pivot joint allowing the post to be rotated to a position flush with the cantilever arm.

10. The boat mounted receptacle support bracket of claim 1 further comprising an anchor at the bottom of the post securing the post within the fishing rod holder.

11. The boat mounted receptacle support bracket of claim 1 wherein the anchor comprises a toggle bolt.

12. The boat mounted receptacle support bracket of claim 1 wherein the anchor comprises a butterfly toggle bolt.

13. The boat mounted receptacle support bracket of claim 1 wherein the receptacle support bracket supports a net.

14. The boat mounted receptacle support bracket of claim 1 further comprising a lid placed over the frame.

15. The boat mounted receptacle support bracket of claim 14 further comprising an anchor at the bottom of the post securing the post within the fishing rod holder.

16. The boat mounted receptacle support bracket of claim 15 further comprising one or more pivot joints.

17. A boat mounted receptacle support bracket comprising:
an elongate post having a top and a bottom, wherein the bottom of the post is capable of being inserted into a fishing rod holder on a boat;
a receptacle support bracket;
a cantilever arm having a proximal end attached to the top of the post and a distal end attached to the receptacle support bracket.

18. The boat mounted receptacle support bracket of claim 17 wherein an anchor at the bottom of the post is capable of securing the post within the fishing rod holder.
